(19) United States
(12) Patent Application Publication
(10) Pub. No.: US 2022/0328841 A1
(43) Pub. Date: Oct. 13, 2022

(54) METHOD OF PREPARING CARBON-COATED CATHODE ACTIVE MATERIAL BASED ON XLi2MNO3-(1-X)LiMO2 (M IS TRANSITION METAL SUCH AS NI, CO, OR MN) FOR LITHIUM SECONDARY BATTERY

(71) Applicant: ENPLUS CO.,LTD., Hwaseong-si (KR)

(72) Inventors: Taekyoung KANG, Cheonan-si (KR); Jongman WOO, Chungju-si (KR); Hyojin JEON, Seoul (KR); Sunhwan KIM, Siheung-si (KR)

(73) Assignee: ENPLUS CO.,LTD., Hwaseong-si (KR)

(21) Appl. No.: 17/712,335

(22) Filed: Apr. 4, 2022

(30) Foreign Application Priority Data
Apr. 13, 2021 (KR) 10-2021-0047800

(51) Int. Cl. H01M 4/62; H01M 4/36; H01M 4/505; H01M 4/525

(52) U.S. Cl. CPC H01M 4/625; H01M 4/366; H01M 4/505; H01M 4/525; H01M 2004/028

(57) ABSTRACT

Proposed is a method of preparing a cathode active material for a lithium secondary battery, in which the active material is based on xLi₂MnO_{3-(1-X)}LiMO₂ (M=Ni, Co, and Mn) and coated with carbon on the surface thereof. The method includes preparing an aqueous metal solution by selecting three metals among nickel, cobalt, iron, manganese, and aluminum, mixing a precipitating agent and a coprecipitating agent with the aqueous metal solution, introducing the mixture into a continuous reactor and stirring the mixture to obtain a precursor, and preparing a cathode active material by heat-treating the precursor along with a lithium salt and a heterogeneous element.

### CROSS REFERENCE TO RELATED APPLICATION

The present application claims priority to Korean Patent Application No. 10-2021-0047800, filed Apr. 13, 2021, the entire contents of which is incorporated herein for all purposes by this reference.

### BACKGROUND OF THE INVENTION

### 1. Field of the Disclosure

The present disclosure relates to a carbon-coated cathode active material for a lithium secondary battery and to a method of preparing the same, in which the cathode active material is a lithium-rich compound containing carbon in a surface layer thereof. More particularly, the present disclosure relates to a method of preparing a lithium secondary battery cathode active material having excellent characteristics in output power, electrochemical properties, and capacity per unit volume, and to a lithium battery including the same.

### 2. Description of the Related Art

Nowadays, Most people carry portable electronic information-and-communication devices thanks to the rapid development of the electronic information and communication industry. Such electronic devices are becoming more and more smaller and lightweight to meet convenient carrying.

In addition, as the lithium secondary battery industry which produces power supply systems for energy storage occupies a significant position, and international competition intensifies, expectations for the technological development of lithium secondary batteries are also increasing. For this reason, research and development of core materials such as a cathode, an anode, and electrolyte core materials are being actively carried out, and among them, research on cathode active material is being conducted most actively.

Lithium secondary batteries, which were previously used as power sources for small electronic devices, are required for a power source for electric vehicles such as HEV (Hybrid electric vehicle), PHEV (Plug-in hybrid electric vehicle), and EV (Electric vehicle) due to the energy crisis and environmental concerns. As a result, a lithium secondary battery for electric vehicles having a high output and high energy density is required. In order to cope with the conditions required for the output of these electric vehicles, lithium secondary batteries need to be significantly improved in price, stability, output power, energy density, and battery life.

Among the various components of a secondary battery, one of the most influential factors on capacity and characteristics is the cathode material. LiCoO₂, which was commercialized in 1991, has been mainly used as a cathode material so far. LiCoO₂ has been used as a cathode material for most lithium secondary batteries so far due to its easy synthesis, flat voltage curve, and excellent cycle characteristics within a certain range. However, it is required to develop a new cathode material for secondary batteries due to increased cost due to insufficient capacity of about 145 mAh/g, unstable thermal stability, the soaring price of cobalt (Co), and harmfulness to humans. Therefore, cathode materials such as nickel-based LiNiO₂, three-component Li[NiCoMn]O₂, manganese-based LiMn₂O₄, and iron-based LiFePO₄ are being researched and developed. Among them, Li₂MnO₃with an electrochemically inactive Mn⁴⁺ oxidation state, and Li[LiNiCoMn]O₂, which is a solid solution of Li[NiCoMn]O₂, have a high capacity of 250 mAh/g or more. In the above oxides, the occupancy of the cation occupying the 3b site is 1, and the sum of the oxidation numbers is 3. In particular, Mn^{3+/4+} oxidation/reduction reaction occurs in the existing manganese oxide, but since the cathode active materials maintain an oxidation state of Mn⁴⁺, the Mn³⁺ Jahn-Teller effect is not large, and thus the performance of the electrode is not significantly degraded. However, the cathode active material is a solid solution up to a certain critical composition, but above the certain critical composition, the properties of the complex appear.

This characteristic shows a flat voltage around 4.45 V during charging. The initial irreversible capacity loss is caused by the formation of Li₂O is generated from Li₂MnO₃ during charging.

In addition, since the amount of residual Li₂MnO₃ is determined according to the cut-off voltage of the charging, the higher the charging voltage, the lower the residual amount. The initial irreversible Li₂MnO₃ causes structural damage as the cycle progresses, reduces the charging and discharging efficiency of lithium, and reduces electrochemical properties. Li₂MnO₃, which is electrochemically inert, has low electrical conductivity, so the conductivity needs to be enhanced.

In order to overcome such disadvantages, research has been actively conducted to modify a surface by coating a surface of a cathode material with various materials in order to suppress a reaction between a cathode interface and an electrolyte during charging and discharging.

### SUMMARY OF THE INVENTION

The present disclosure is to solve the above problems. An objective of the present disclosure is to provide a cathode active material for a lithium secondary battery with excellent output characteristics and cycle lifespan characteristics by coating the surface of the cathode active material.

A first objective of the present disclosure is to provide a method for manufacturing a composite metal oxide, which is a precursor for a cathode active material for a lithium secondary battery, the method including: preparing an aqueous metal solution by selecting three types among nickel, cobalt, iron, manganese, and aluminum; mixing a precipitating agent and a coprecipitating agent in an aqueous metal solution, introducing the mixture into a continuous reactor and stirring the mixture to obtain a precipitate; and preparing a precursor by filtering and washing the precipitate and drying the precipitate; preparing a composite metal oxide by coating the surface of the prepared cathode active material.

The precipitating agent may be a caustic soda or sodium carbonate, and the coprecipitating agent may be aqueous ammonia.

The step of preparing the aqueous metal solution may include preparing an aqueous metal solution using distilled water as a solvent in manganese sulfate hydrate, nickel sulfate hydrate, and cobalt sulfate hydrate.

The mass ratio of manganese, nickel, and cobalt may be 0.5 to 0.7:0.1 to 0.3:0.1 to 0.2.

The aqueous metal solution, sodium carbonate, and aqueous ammonia may be mixed in a molar ratio of 1:1 to 2:0.1 to 0.5.

In the step of obtaining precipitates by stirring, an aqueous metal solution, sodium carbonate, and ammonia water are introduced into the continuous reactor using a metering pump, and the stirring speed is set to 500 rpm to 3000 rpm.

The step of preparing a precursor may include preparing a precursor by drying the precipitate at 100° C. to 150° C. after filtering and washing.

A second objective of the present disclosure is to provide a composite metal oxide, a precursor for a cathode active material for a lithium secondary battery characterized by being prepared by the aforementioned method for preparing the composite metal oxide.

A third objective of the present disclosure is to provide a method for manufacturing a cathode active material for a lithium secondary battery, the method including: preparing an aqueous metal solution by selecting three kinds among nickel, cobalt, iron, manganese, and aluminum; mixing sodium carbonate as a precipitating agent and ammonia water as a coprecipitation agent into an aqueous metal solution, introducing the mixture into a continuous reactor and stirring the mixture to obtain a precipitate; preparing a precursor by filtering and washing the precipitate and drying the precipitate; mixing the precursor with a lithium salt.

A method of manufacturing a cathode active material for a lithium secondary battery includes coating a surface of the manufactured cathode active material with carbon particles.

In the present disclosure by means of the above solving problems, a carbon-coated cathode active material is prepared by adding a graphene aqueous solution to improve electrical conductivity, thereby improving charging/discharging cycle characteristics, lifespan characteristics, high rate characteristics, and replacing conventional cathode active material electrode substances for lithium secondary batteries.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram showing an XRD pattern (pattern) graph of the graphene-coated Li[LiₓM]O₂ (0<X<0.9, M=Ni:Co:Mn) powder according to the present disclosure;

FIGS. 2A and 2B are SEM photographs of graphene-coated Li[LiₓM]O₂ (0<X<0.9, M=Ni:Co:Mn) powder according to the present disclosure, (a): Comparative Example, (b): Example;

FIG. 3 is a carbon distribution photograph of a graphene-coated Li[LiₓM]O₂ (0<X<0.9, M=Ni:Co:Mn) powder according to the present disclosure, (b): Comparative Example;

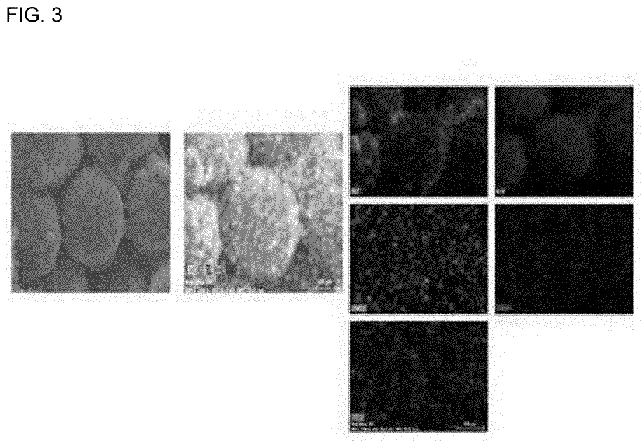

FIG. 4 is a diagram showing an initial charge/discharge graph according to a cycle when an experiment is performed at a predetermined current density of 17 mA/g at a voltage range of 2.0 to 4.6 V according to the present disclosure;

FIG. 5 is a diagram showing an initial charge/discharge graph according to a cycle as dq/dv when an experiment is performed at a predetermined current density of 17 mA/g at a voltage range of 2.0 V to 4.6 V according to the present disclosure;

FIG. 6 is a diagram showing cycle life characteristics according to a current density of 17 mA/g in a voltage range of 2.0 to 4.6 V according to the present disclosure; and

FIG. 7 is a view showing a surface resistance according to AC impedance measurement of an anode active material prepared according to the present disclosure.

### DESCRIPTION OF THE PREFERRED EMBODIMENTS

Hereinafter, preferred embodiments of the present disclosure will be described in detail with reference to the accompanying drawings. Advantages and features of the present disclosure and methods of achieving them will become apparent with reference to the embodiments described below in detail in conjunction with the accompanying drawings. However, the present disclosure is not limited to the embodiments disclosed below but may be implemented in various different forms, only to ensure that the disclosure of the present disclosure is complete and to fully inform the scope of the disclosure to those skilled in the art, and the present disclosure is defined by the scope of claims.

When adding reference numerals to the components of each drawing, it should be noted that the same components have the same reference numerals as much as possible even though they are indicated in different drawings. In addition, in describing the present disclosure, if it is determined that a detailed description of a related known configuration or function may obscure the gist of the present disclosure, the detailed description thereof will be omitted.

Unless otherwise defined, all terms (including technical and scientific terms) used herein may be used with the meaning commonly understood by those of ordinary skilled in the art to which the present disclosure belongs. In addition, terms defined in a commonly used dictionary are not to be interpreted ideally or excessively unless clearly specifically defined. The terminology used herein is for the purpose of describing the embodiments and is not intended to limit the present disclosure. In the present specification, the singular form also includes a plural form unless specifically specified in the phrase.

In addition, in describing the components of the present disclosure, terms such as first, second, A, B, (a), (b), etc., may be used. These terms are only intended to distinguish their components from other components, and the nature, sequence, or order of the components are not limited by the terms. If a component is described to be “connected”, “coupled”, or “connected” to another component, the component may be directly connected or connected to the other component, but another component is between each component. It should be understood that another component may be “connected”, “coupled”, or “connected” between each component.

As used in the specification, the term “comprises” and/or “comprising” does not preclude the presence or addition of one or more other components, stages, operations and/or devices mentioned.

### EXAMPLE 1

### Preparation Of Carbon-Coated Cathode Active Material

In order to achieve the above objective, the present disclosure provides a method of manufacturing a cathode active material powder for a lithium secondary battery, the method including: preparing, as raw material, an aqueous metal solution prepared by selecting three elements among Ni, Co, Fe, Mn, and Al, by the new composition formula M=Ni, Co, Fe, Mn, in which three elements are controlled to 1 (i.e., a+b+c=1) (step 1); preparing a precursor (MCO₃ M=Ni, Fe, Mn, Co, and Al) in which the precursor has uniform particle size and controlled uniform spherical surface shape, using the raw material prepared in step 1 as a chelating agent and prepared carbonate as a precipitating agent (step 2); mixing the precursor prepared in step 2 with a lithium salt and then calcinating the precursor in an inert gas or oxygen atmosphere in the air (step 3); and coating the surface of the active material prepared in step 3 with carbon using graphene (step 4).

Hereinafter, a method for manufacturing a cathode active material according to the present disclosure will be described in detail step by step.

Step 1 is preparing the raw material in an aqueous solution state. Manganese sulfate monohydrate (MnSO₄.1H₂O), nickel sulfate hexahydrate (NiSO₄.6H₂O), and cobalt sulfate heptahydrate (CoSO₄.7H₂O) were used as raw materials.

An aqueous solution was prepared using distilled water as a solvent by quantification (Mn:Ni:Co=0.67:0.33:0.1) in an accurate stoichiometric ratio.

Step 2 is preparing a precursor, and a molar ratio of sodium carbonate (Na₂CO₃), which can precipitate the produced aqueous solution, is 1:2 (aqueous solution: precipitating agent), where 0.4 mol of ammonia, which is a coprecipitation agent, is mixed and introduced into a continuous reactor using a metering pump. The stirring speed was adjusted to 1000 rpm. After the precipitation reaction was completed, the precursor was filtered and washed and dried in an oven at 120° C.

Step 3 is mixing the prepared precursor with a lithium salt and a heterogeneous element. After adding and mixing 1.6 times lithium carbonate (Li₂CO₃) compared to the precursor, after primary heat treatment at 500° C. for 8 hours 20 minutes, and after heat treatment at 950° C. for 15 hours 30 minutes again, Li[LiₓM]O₂ (0<X<0.9), (M=Ni:Co:Mn) powder was obtained.

In stage 4, the surface of the cathode active material was coated using GO solution containing carbon by a liquid method and then heat-treated at 600° C. for 4 hours to obtain coated Li[LiₓM]O₂ (0<X<0.9), (M=Ni:Co:Mn) powders.

### EXAMPLE 2

### Preparation of Carbon-Coated Cathode Active Material

The concentration of GO solution was adjusted to 0.1 wt % and prepared in the same manner as in Example 1.

### EXAMPLE 3

### Preparation of Carbon-Coated Cathode Active Material

The concentration of GO solution was adjusted to 3 wt % and prepared in the same manner as in Example 1.

### COMPARATIVE EXAMPLE 1

### Preparation of Cathode Active Material

The cathode active material was prepared by performing the same procedure as in Example 1 above, and the chemical composition of the lithium metal composite oxide obtained as a result was Li[LiₓM]O₂ (0<X<0.9) (M=Ni:Co:Mn). Since no coating treatment was performed, carbon was not present on the surface of the cathode active material.

### EXPERIMENTAL EXAMPLE 1

### XRD Measurement

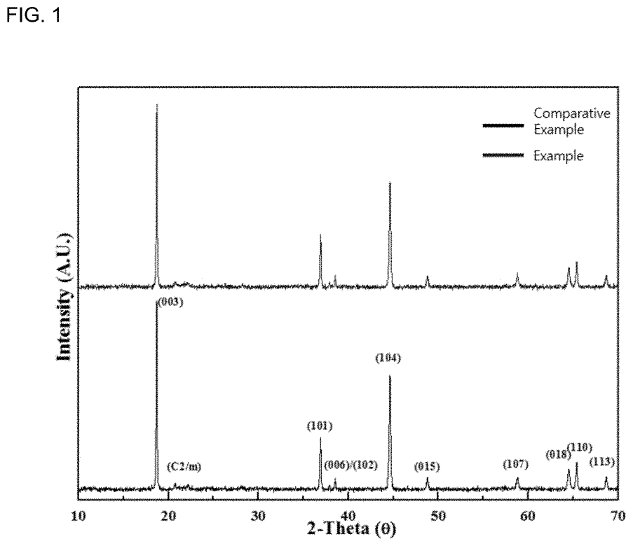

XRD analysis was performed for structural analysis of all lithium metal composite oxides prepared in Example 1 and Comparative Example 1, and the results are shown in FIG. 1.

Table 1 shows the results of XRD analysis, and it was confirmed that the Cation mixing (I003/I104) and R-factor values shown in Example 1 were higher than the measured values in the comparative example.

TABLE 1

| | | | | | | R-factor |
|---|---|---|---|---|---|---|
| | | | | | | ([I006 + |
| | a | c | | Volume | I003/ | I102])/ |
| No. | (Å) | (Oh) | c/a | (Å³) | I104 | I101) |
| Example 1 | 2.8543 | 14.2192 | 4.9817 | 100.3208 | 1.5507 | 0.3311 |
| Comparative | 2.8557 | 14.2333 | 4.9842 | 100.4469 | 1.6561 | 0.3149 |
| Example 1 | | | | | | |

### EXPERIMENTAL EXAMPLE 2

### SEM Measurement

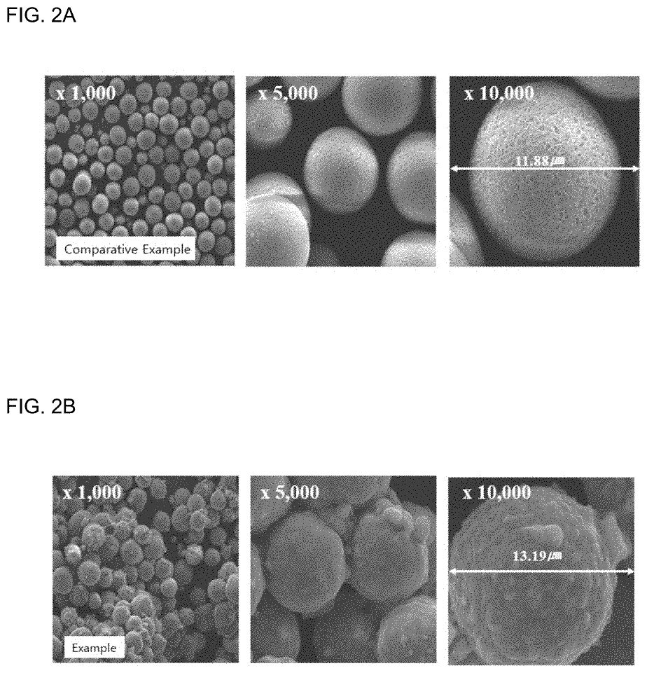

In order to observe the particle shape and surface of all lithium metal composite oxides prepared in Example 1 and Comparative Example 1, the particles were observed with a scanning electron microscope (SEM), and the results are shown in FIGS. 2A and 2B. The average particle size was 11 μm to 13 μm, and it was confirmed that the particle size increased by about 10% to 12% when carbon atoms were coated on the surface of the active material.

### EXPERIMENTAL EXAMPLE 3

### Coin Half Cell Test

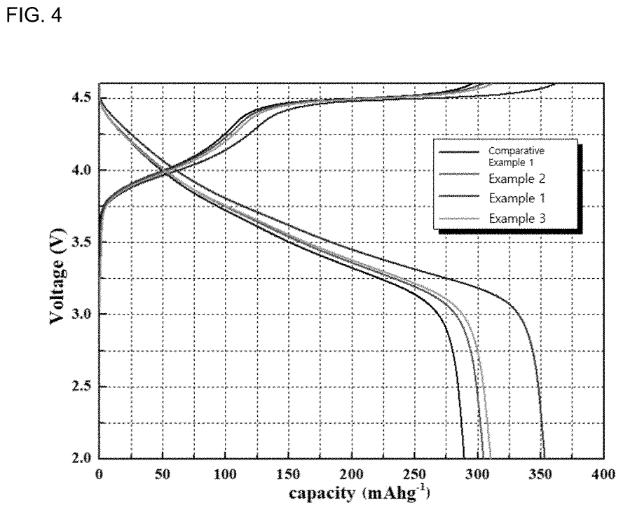

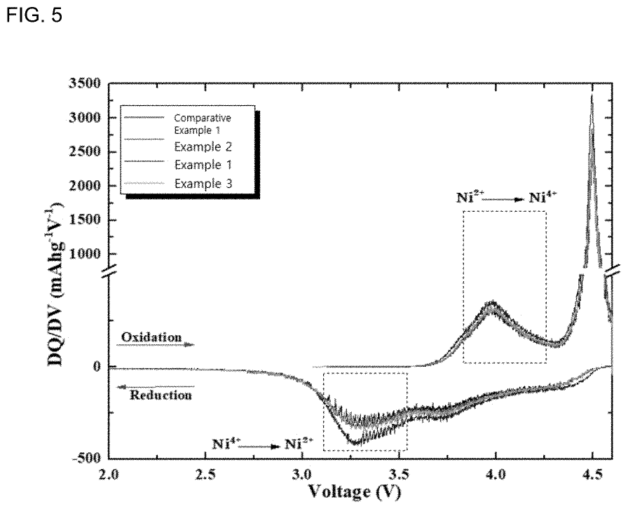

A slurry was prepared by mixing the cathode active materials synthesized in Example 1 and Comparative Example 1, carbon black as a conductive agent, and polyvinylidene fluoride (PVDF) as a binder with NMP (N-methylene-2-pyrrolidone) as an organic solvent at a weight ratio of 90:5:5, and then applied to 25 μm of Al foil to prepare a cathode. The results of assembling the CR 2032 type coin cell and performing a charge/discharge test at 2.0 V to 4.6 V with a current density of 0.1 C in order to measure the electrical characteristics of the prepared positive electrode are shown in FIGS. 4 and 5.

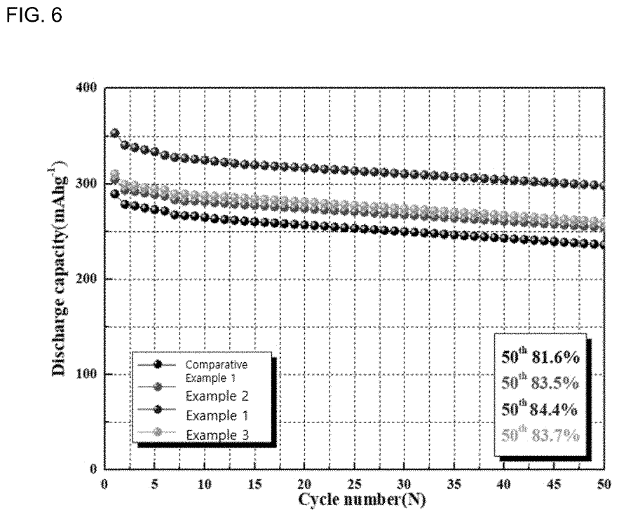

For measuring the lifespan characteristics, Examples 1, 2, 3, and Comparative Example 1 were measured for a current density of 17 mA/g and an efficiency of 50 cycles, and the results are shown in FIG. 6.

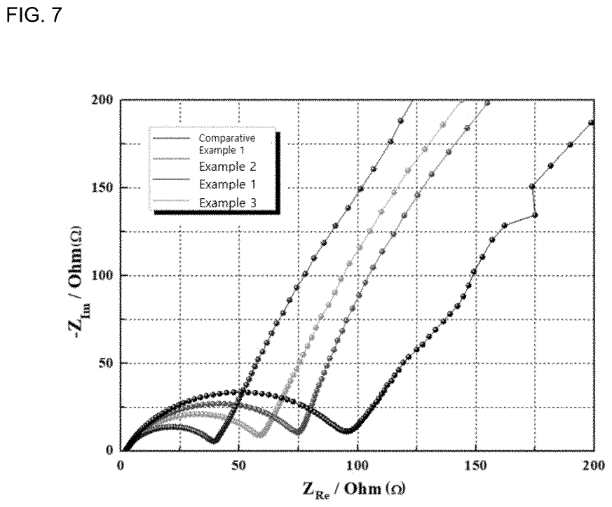

In addition, AC Impedance measurement was performed to confirm the resistance value of the prepared cathode active material, and the results are shown in FIG. 7.

Although embodiments of the present disclosure have been described above with reference to the accompanying drawings, those of ordinary skilled in the art to which the present disclosure pertains can realize that the present disclosure can be embodied in other specific forms without changing the technical spirit or essential features. Therefore, it should be understood that the embodiments described above are illustrative in all respects and not restrictive. The protection scope of the present disclosure should be construed by the following claims, and all technical ideas within the scope equivalent thereto should be construed as being included in the scope of the present disclosure.

What is claimed is:

1. A method of preparing a composite metal oxide serving as a precursor for a carbon-coated cathode active material for a lithium secondary battery, the method comprising:
preparing an aqueous metal solution by selecting three metals among nickel, cobalt, iron, manganese, and aluminum; and
obtaining a precursor by adding a precipitating agent and a coprecipitating agent to the aqueous metal solution, introducing the resulting mixture into a continuous reactor, and stirring the mixture; and
preparing a cathode active material by heat-treating the precursor along with a lithium salt and a heterogeneous element.

2. The method of claim 1, wherein the precipitating agent is sodium carbonate, and the coprecipitating agent is aqueous ammonia.

3. The method of claim 1, wherein the preparing of the aqueous metal solution is to prepare an aqueous metal solution by using distilled water as a solvent and using manganese sulfate hydrate, nickel sulfate hydrate, and cobalt sulfate hydrate as solutes.

4. The method of claim 3, wherein the metal aqueous solution is prepared by selecting manganese, nickel, and cobalt, and the mass ratio of manganese, nickel, and cobalt is 0.5 to 0.7:0.1 to 0.3:0.1 to 0.2.

5. The method of claim 2, wherein the metal aqueous solution, the sodium carbonate, and the aqueous ammonia are mixed in a molar ratio of 1:1 to 2:0.1 to 0.5.

6. The method of claim 5, wherein the aqueous metal solution, the sodium carbonate, and the ammonia water were introduced into the continuous reactor using a metering pump and stirred at a speed of 500 to 3000 rpm to obtain the core part.

7. The method of claim 1, wherein the obtaining of the precursor is a process of drying at 100 to 150° C. after filtration and washing.

8. A composite metal oxide serving as a precursor for a carbon-coated cathode active material for a lithium secondary battery, the composite metal oxide being prepared by the method of claim 1.

9. A method of preparing a carbon-coated cathode active material for a lithium secondary battery, the method comprising:
preparing an aqueous metal solution by selecting three types among nickel, cobalt, iron, manganese, and aluminum;
obtaining a precursor by mixing a precipitating agent and a coprecipitating agent with the aqueous metal solution, introducing the mixture into a continuous reactor, and stirring the mixture;
preparing a cathode active material by heat-treating the precursor along with a lithium salt and an heterogeneous element and by using graphene as a coating agent.

10. The method of claim 9, further comprising:
performing a first thermal treatment at a first specific temperature after mixing the precursor, the lithium salt, and the heterogeneous elements
performing a second heat-treating at a second specific temperature.

11. The method of claim 10, wherein the first heat-treating is performed at a first specific temperature of 400° C. to 750° C. for 4 hours to 12 hours, and the second heat-treating is performed at a second specific temperature of 700° C. to 1000° C. for 4 hours to 24 hours.

12. The method of claim 9, wherein the lithium salt is lithium carbonate, the coating agent is an aqueous solution of graphene oxide, the molar ratio of the precursor and the lithium carbonate is in a range of 1:1 to 3, and the volume ratio of the prepared active material and the aqueous solution of graphene oxide is in a range of 1:0.1 to 3.

13. The method of claim 11, further comprising a third heat treatment for the graphene-coated active material at a third specific temperature in a range of 200° C. to 700° C. for 0.5 to 6 hours.

14. A carbon-coated cathode active material for a lithium secondary battery, the cathode active material prepared by the method of claim 9.
